(19) United States
(12) Patent Application Publication
(10) Pub. No.: US 2010/0208086 A1
(43) Pub. Date: Aug. 19, 2010

(54) REDUCED-MEMORY VIDEO STABILIZATION

(75) Inventors: Sreenivas Kothandaraman, Garland, TX (US); Aziz U. Batur, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/389,123

(22) Filed: Feb. 19, 2009

(51) Int. Cl. H04N 5/222

(52) U.S. Cl. 348/208.4; 348/E05.022

(57) ABSTRACT

A system and method for performing video stabilization in a reduced memory video device. In one embodiment, a system includes a frame memory and a video stabilizer. The frame memory stores a first video frame and a second video frame acquired after the first video frame. The video stabilizer determines a motion vector indicative of movement of the system between acquisition of the first and second video frames. The determination is based, at least in part, on the first video frame. A number of pixels stored for the second video frame is greater than a number of pixels stored for the first video frame.

### BACKGROUND

The use of video recording devices continues to expand worldwide. With the commercialization of digital image recording, distinctions between devices intended for still image a capture and devices intended to record video have diminished. For example, devices such as cellular telephones and commonplace digital cameras are capable of recording video sequences in addition to still images. Unfortunately, some users of video recording devices have difficulty maintaining the device in a stable position during video capture. Movement of the recording device during use can result in poor quality videos wherein the frame location of recorded subjects may randomly change over a sequence of frames. In extreme cases, such image instability can make a video recording unviewable. In other cases, such image instability is undesirable in that it does not reflect actual subject movement. To reduce the undesirable effects of camera instability, video recording devices implement various video stabilization schemes.

Some stabilizing methods attempt to stabilize an image prior to acquisition. Optical compensation methods incorporate floating optical elements that move counter to the remainder of the camera in order to maintain the position of subjects within successive frames. Camera movement can be detected by motion sensors, for example, accelerometers or gyroscopic sensors, included in the camera body or lens components. Optical stabilization methods can produce good results, but require space to accommodate the moving optical elements, and the hardware required to stabilize the optics can add significant cost to the camera. A similar stabilization method uses fixed optics and moves the image sensor in response to camera motion.

Some stabilizing methods apply post acquisition processing to compensate for camera motion. An electronic stabilization system uses motion sensor data to adjust the position of a previously acquired image. Digital image stabilization compares a current frame to a previous frame to estimate camera movement, and adjusts the image of the current frame to compensate for the estimated camera motion.

To reduce the cost of video recording devices, it is desirable to reduce the costs associated with video stabilization.

### SUMMARY

A system and method for performing video stabilization with reduced memory requirements are disclosed herein. In accordance with at least some embodiments, a system includes a frame memory and a video stabilizer. The frame memory stores at least a portion of a first video frame and also stores a later acquired second video frame. The video stabilizer determines a global motion vector for the second video frame based, at least in part, on the first video frame. A number of pixels stored for the second video frame is greater than a number of pixels stored for the first video frame.

In accordance with at least some other embodiments, a method includes acquiring a full resolution first video frame. A reduced resolution version of the first video frame is produced. At least a portion of the reduced resolution version of the full resolution first video frame is stored. A full resolution second video frame is acquired and stored in the video device. A reduced resolution version of the second video frame is produced and stored. A global motion vector for the reduced resolution version of the second video frame is determined after the full resolution first video frame is discarded. A stabilized image is produced from the full resolution second video frame.

In accordance with yet other embodiments, a video recording device includes an image sensor, a video processor, and a frame memory. The image sensor converts light into an electrical signal representative of an image. The video processor converts the electrical signal into a plurality of full resolution video frames. The frame memory stores video frames. The video processor includes a video stabilizer that purges the frame memory of all full resolution video frames acquired prior to a given full resolution video frame before the video stabilizer determines a global motion vector for the given video frame.

### BRIEF DESCRIPTION OF THE DRAWINGS

For a detailed description of exemplary embodiments of the invention, reference will now be made to the accompanying drawings in which:

FIG. 1 shows a block diagram of an exemplary video device that includes reduced memory video stabilization in accordance with various embodiments;

FIG. 2 shows an exemplary reference frame and an exemplary frame to be stabilized in accordance with various embodiments; and

FIG. 3 shows a flow diagram for a method for performing reduced memory video stabilization in a video device in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are a system and method for stabilizing video acquired in video devices that include limited memory resources. As video acquisition and recording devices become smaller and lighter, stable hand-held operation of the devices becomes more difficult, making inclusion of video stabilization features in such devices increasingly important. Concomitantly, competitive pressures require that the cost of video devices be reduced. Embodiments of the present disclosure facilitate application of digital image stabilization processing in reduced memory video devices by storing both full and reduced resolution versions of the current frame and only a reduced resolution reference frame for use in stabilization motion estimation. By storing fewer reference frames pixels, embodiments reduce the amount of frame memory required in the device, and thereby reduce the cost of the device. The term resolution, as used herein refers to the number of pixels used to represent an image. Thus, a reduced resolution version of an image uses fewer pixels than a full resolution version of the image.

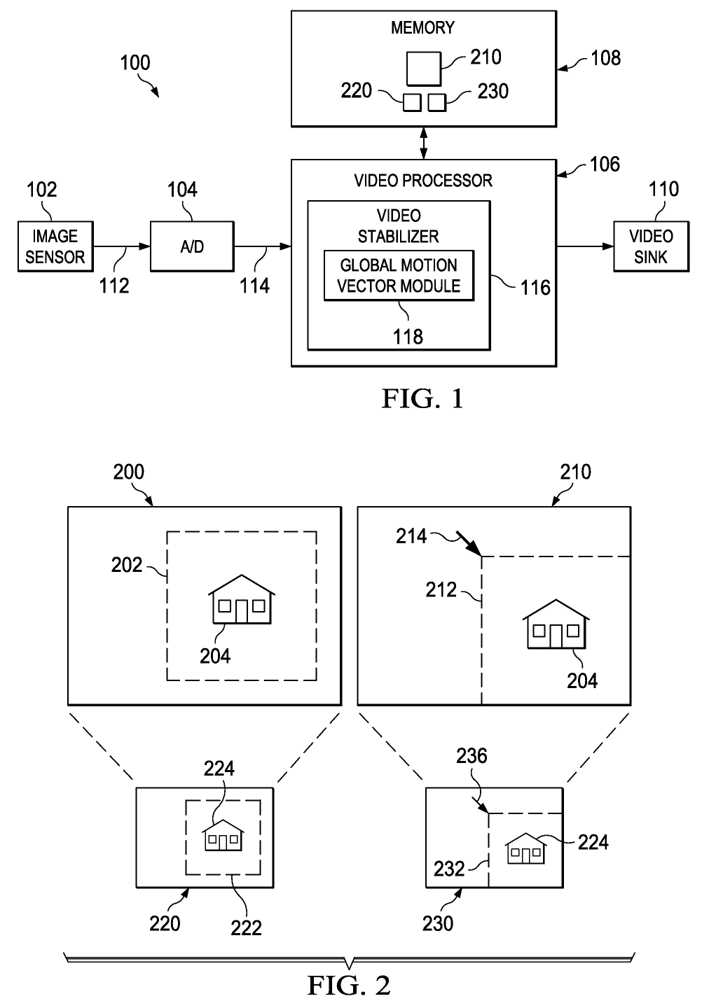

FIG. 1 shows a block diagram of an exemplary video device 100 that includes reduced memory video stabilization in accordance with various embodiments. The video device 100 comprises an image sensor 102, an analog-to-digital converter (“A/D”) 104, a video processor 106, a memory 108, and a video sink 110. In practice, a video device may include various other components and systems, for example, one or more optical lenses, a shutter system, various filters and/or amplifiers applied to the analog image data 112, operator controls and displays, etc.

The image sensor 102 converts light directed onto the surface of the sensor 102 into an electrical signal 112 representative of an image formed by the illumination of the sensor 102. The image sensor 102 can comprise a plurality of individual photodetectors. The photodetectors may be arranged in a two-dimensional array of rows and columns with one or more photodetectors combining to form individual pixels of the image. Each row of photodetectors may be consecutively scanned to produce the signal 112. The electrical signal 112 can include representations of the color and/or intensity of the light detected by each individual photodetector. For example, the sensor 102 photodetectors may detect red, green, and blue light, and correspondingly these colors may be represented in the electrical signal 112. Each portion of the signal 112 comprising a complete scan of image sensor 102 photodetectors constitutes a frame of video data. Various image sensor technologies, for example, charge coupled devices (“CCD”), complementary metal oxide semiconductor (“CMOS”) image sensors, etc., are applicable to embodiments of the video device 100.

The A/D converter 104 converts the analog signal 112, containing image frame data, to digital frame data 114. The digital frame data 114 is provided to the video processor 106. In some embodiments, the video processor 106 can be, for example, a digital signal processor, or general-purpose processor that executes software programming to provide control of the video device 100 and/or various video data processing functions, such as filtering, encoding, etc. In some embodiments, the video processor 106 can include hardware circuitry or co-processors to accelerate various video processing functions. The components of a processor are well known to those skilled in the art, and can comprise, for example, execution units (e.g., fixed/floating point, integer, etc), storage units (e.g., registers, memory, etc.), instruction decoding units, input/output ports, various peripherals (e.g., direct memory access controllers, interrupt controllers, communication controllers, timers, etc.).

In embodiments of the present disclosure, the video processor 106 comprises a video stabilizer 116. The video stabilizer 116 processes the digital frame data 114 to reduce objectionable frame-to-frame jitter caused by movement of the video device 100. The video stabilizer 116 can be implemented as software programming executed by the processor 106, or as hardware circuitry, or as a combination of hardware circuitry and software programming.

Embodiments of the video stabilizer 116 include a global motion vector module 118. To perform frame-to-frame stabilization of video images, the global motion vector module 118 determines how elements of a frame have moved in relation to the same elements of a previously acquired frame. Thus, the global motion vector module 118 provides a global motion vector indicative of how movement of the video device 100 affects the positioning of image elements in the current frame relative to the positioning of the same image elements in a previous frame.

FIG. 2 shows an exemplary reference frame 200 and an exemplary frame 210 to be stabilized in accordance with various embodiments. Frame 200 represents a frame (i.e., a reference frame) previously acquired by the video device 100. The reference frame 200 includes more pixels than a reference image window 202 that is provided as a stabilized image. The reference frame 200 includes elements 204 within the reference window image 202. A second frame 210 is acquired by the video device 100 subsequent to frame 200, and is to be stabilized. As shown, the elements 204 are present in frame 210, but are located at different positions in frame 210 and frame 200. As a matter of simplification, it is assumed herein that the movement of the elements 204 is due to movement of the video device 100 between acquisitions of the two frames. In practice, a video stabilizer 116 may ascertain whether movement of an element is independent of device 100 movement. The effects of such independent movements on determination of the global motion vector are preferably minimized. In the example of FIG. 2, the relocation of the elements 204 in frame 210 is due to movement of the video device 100 upward and to the left after frame 200 was acquired. Thus, a stabilized image may be provided by selecting a window image 212 in the frame 210 that includes the elements 204 in approximately the same locations as the elements 204 occupy in the reference window image 202. The location of the window image 212 is determined, in at least some embodiments, by application of a global motion vector 214 referenced to a point (e.g., the same point) of the reference window image 202.

Referring again to FIG. 1, the memory 108 is provided to store data and/or programming for access by the video processor 106. More specifically, the memory 108 stores the digital image frames for stabilization processing. The portion of the memory 108 that stores video frames may be referred to as “frame memory.” In some embodiments of the present disclosure, the memory 108 stores the reduced resolution reference image 220, and both a reduced resolution version 230 and full resolution version 210 of a frame that is to be stabilized. The memory 108 can comprise various types of memory devices, for example, static or dynamic random access memory, FLASH memory, read-only memory, etc, as required to store data and/or programming. In at least some embodiments, the memory 108 used to store digital image frames 210, 220, 230 for stabilization processing is included on the same integrated circuit die as the video processor 106.

Embodiments of the present disclosure store only a reduced pixel count reference frame 220, rather than a full resolution reference frame 200 for use in global motion vector estimation. The low-resolution reference frame 220 requires less memory 108 storage that the full resolution reference frame 200. For example, in some embodiments, the reference frame 220 may require ¼ the memory of the reference frame 200, resulting in a substantial memory saving. The low-resolution reference frame 220, includes a reference window image 222, and elements 224 corresponding to window 202 and elements 204 of frame 200.

Embodiments also store a reduced pixel count version 230 of the frame to be stabilized. The global motion vector module 118 processes the reduced pixel count frames 220, 230 to determine how the image elements 224 have moved, and computes a global motion vector 236 based on the detected motion. The global motion vector module 118 scales the global motion vector 236 to accommodate the difference in resolution between the frames 230 and 210 to produce the scaled global motion vector 214 that the video stabilizer 116 uses to select a stabilized image window 212 in the full resolution video frame 210. In at least some embodiments, the global motion vector module 118 uses sub-pixels (e.g., individual image sensor elements that combine to form a pixel) to determine global motion vector 236 with sub-pixel accuracy. By applying sub-pixel processing to the global motion vector 236 determination, embodiments improve the accuracy of the global motion vector 236.

The video processor 108 generates the low-resolution frames 220, 230 by, for example, down sampling the full-resolution frames 200, 210, or applying other resolution reduction schemes known in the art. Various embodiments may store only the reduced resolution reference window image 222, rather than the reference frame 220 for comparison with frame 210.

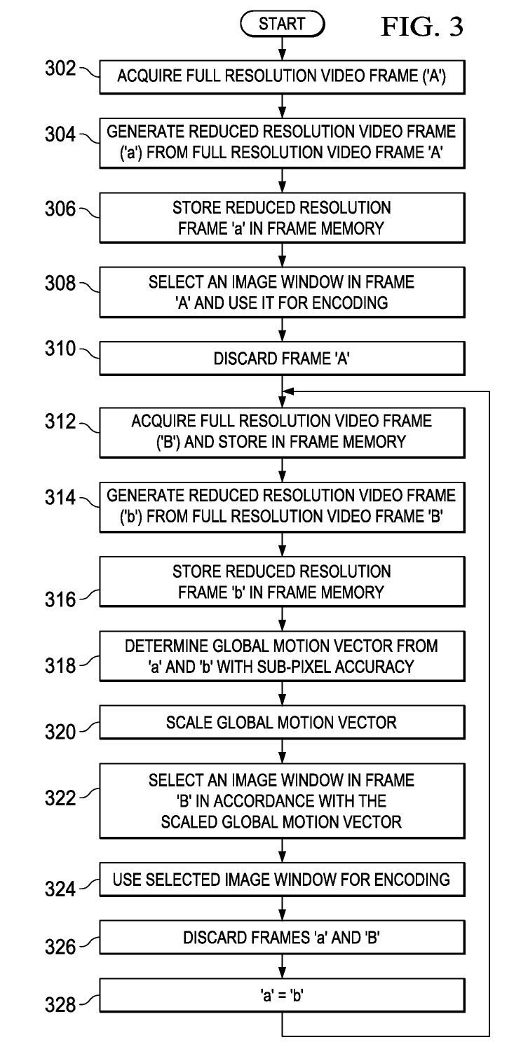

FIG. 3 shows a flow diagram for a method for performing reduced memory video stabilization in a video device 100 in accordance with various embodiments. Though depicted sequentially as a matter of convenience, at least some of the actions shown can be performed in a different order and/or performed in parallel. Additionally, some embodiments may perform only some of the actions shown. In at least some embodiments, the operation of FIG. 3 can be realized as software instructions stored in memory 108 and executed by the video processor 106.

In block 302, the video device 100 acquires a full resolution video frame (‘A’) 200. The video frame ‘A’ is processed by the video processor 106, in block 304, to generate a reduced resolution video frame (‘a’) 220. The reduced resolution video frame ‘a’ 220 can be generated by down sampling the full resolution frame ‘A’ 200, or by other methods known in the art. The reduced resolution video frame ‘a’ 220 is stored in frame memory 108 in block 306. The reduced resolution frame ‘a’ 220 can constitute one-half or less the number of pixels that are in the full resolution frame ‘A’ 200. Reducing the number of pixels in the frame ‘a’ 220 produces a corresponding reduction in the storage requirements of memory 108. Some embodiments may store only the reduced resolution version of the image window 222 in memory 108.

In block 308, an image window 202 is selected in full resolution video frame ‘A’ 200. The full resolution video frame ‘A’ 200 preferably includes more pixels (e.g., 10% more pixels) than are used to produce the output image window 202. In some embodiments, the image window 202 may include a predetermined number of pixels centered in the frame ‘A’ 200. The video processor 106 encodes the image window 202 in accordance with a video encoding standard (e.g., MPEG 2, H.264, etc.) and the encoded image window may be provided to the video sink 110 for storage, display, transmission, etc. The full resolution video frame ‘A’ 200 is discarded in block 310.

In block 312, the video device 100 acquires another full resolution video frame (‘B’) 210, and stores the frame 210 in frame memory 108. The full resolution video frame (‘B’) 210 preferably includes more pixels than are used to produce an output image window 212. The video device 100 may have moved between acquisition of the first video frame ‘A’ 200 and the video frame ‘B’ 210 imparting an objectionable jitter to the video. To mitigate the effects of the movement, the video device 100 employs digital video stabilization.

The video frame ‘B’ is processed by the video processor 106, in block 314, to generate a reduced resolution video frame (‘b’) 230. The reduced resolution video frame ‘b’ 230 can be generated by down sampling the full resolution frame ‘B’ 210, or by other methods known in the art. The reduced resolution video frame ‘b’ 230 is stored in frame memory 108 in block 316.

In block 318, the video stabilizer 116 uses the reduced resolution video frame ‘b’ 230 and the reduced resolution video frame ‘a’ 220 (or window 222) to determine a global motion vector 236 for the reduced resolution video frame ‘b’ 230. The global motion vector 236 corresponds to the movement of image elements across the frames 220, 230 attributable to movement of the device 100. In at least some embodiments, the global motion vector 236 can be determined by subdividing the frames 220 and 230 into a plurality of sub-blocks. Correlations between blocks of pixels can be determined to produce candidate motion vectors for the sub-blocks. The candidate motion vectors can be processed to produce the global motion vector 236. Various methods of producing a global motion vector are described in U.S. Pat. Pub. No. 2006/0066728 A1, which is herein incorporated by reference. In at least some embodiments, the global motion vector module 118 determines the global motion vector 236 with sub-pixel accuracy based on the sub-pixels of the reduced resolution video frame ‘a’ 220 and the reduced resolution video frame ‘b’ 230 to improve global motion vector 236 accuracy.

In block 320, the determined global motion vector 236 is scaled according to the ratio of pixels in the full resolution frame 210 and the reduced resolution frame 230 to produce a scaled global motion vector 214 that can be applied to the full resolution frame 210. If, for example, the full resolution frame 210 includes 307,200 pixels, and the reduced resolution reference frame 230 includes 76,800 pixels (¼ the pixels of the full resolution frame), an embodiment can scale the global motion vector 236 by a factor of two to produce a scaled global motion vector 214 applicable to the full resolution frame 210.

In block 322, the video stabilizer 116 applies the scaled global motion vector 214 to the full resolution video frame 210 to select a stabilized image window 212 from the frame 210.

In block 324, encoding (e.g., MPEG 2, H.264, etc.) may be applied to the stabilized frame 212. The encoded stabilized frame may be provided to the video sink 110 for storage, display, transmission, etc.

In block 326, the reduced resolution frame ‘a’ 220 and the full resolution frame ‘B’ 210 are discarded. The portions of memory 118 used to store the discarded frames is free to be re-allocated to, for example, the next video frame.

In block 328, the reduced resolution frame ‘b’ 230 is deemed the reduced resolution reference frame for the next video frame to be stabilized (‘a’=‘b’), and video frame processing continues in block 312 with acquisition of the next frame.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a frame memory that stores a first video frame and a second video frame acquired after the first video frame; and
a video stabilizer that determines a motion vector indicative of movement of the system between acquisition of the first and second video frames, the determination is based, at least in part, on the first video frame;
wherein a number of pixels stored for the second video frame is greater than a number of pixels stored for the first video frame.

2. The system of claim 1, wherein the frame memory stores a full resolution version of the second video frame, a reduced resolution version of the second video frame, and only a reduced resolution version of the first video frame for motion vector determination.

3. The system of claim 2, wherein the video stabilizer determines the motion vector based only on the reduced resolution version of the second video frame and the reduced resolution version of the first video frame.

4. The system of claim 2, wherein the video stabilizer determines the motion vector at a sub-pixel level of the reduced resolution version of the second video frame and the reduced resolution version of the first video frame.

5. The system of claim 1, wherein the video stabilizer scales the motion vector in accordance with a ratio of pixels in a full resolution frame to pixels in a reduced resolution frame to provide a scaled motion vector.

6. The system of claim 5, wherein the video stabilizer selects a portion of the second frame to be an image window based, at least in part, on the scaled motion vector.

7. The system of claim 1, wherein the stored portion of the first frame window comprises a reduced resolution image window.

8. The system of claim 1, wherein the frame memory does not store a full resolution version of the first video frame for determining the motion vector.

9. A method, comprising:
acquiring a full resolution first video frame in a video device;
producing a reduced resolution version of the full resolution first video frame;
storing at least a portion of the reduced resolution version of the first video frame;
discarding the full resolution first video frame before a full resolution second video frame is acquired;
acquiring and storing a full resolution second video frame in the video device;
producing and storing a reduced resolution version of the full resolution second video frame;
determining a global motion vector for the reduced resolution version of the second video frame; and
producing a stabilized image from the full resolution second video frame.

10. The method of claim 9, further comprising determining the global motion vector based only on the reduced resolution version of the first video frame and the reduced resolution version of the second video frame.

11. The method of claim 10, further comprising determining the global motion vector based on sub-pixels of both the reduced resolution version of the first video frame and the reduced resolution version of the second video frame.

12. The method of claim 9, further comprising scaling the global motion vector in accordance with a ratio of full resolution second video frame pixels to pixels in the reduced resolution version of the second video frame.

13. The method of claim 12, further comprising selecting an image window from the stored full resolution second video frame in accordance with the scaled global motion vector.

14. A video recording device, comprising:
an image sensor that converts light into an electrical signal representative of an image;
a video processor that converts the electrical signal into a plurality of full resolution video frames; and
a frame memory that stores video frames;
wherein the video processor comprises a video stabilizer purges the frame memory of all full resolution video frames acquired prior to a given full resolution video frame before the video stabilizer determines a global motion vector for the given video frame.

15. The video recording device of claim 14, wherein the video processor stores in the frame memory only the given full resolution video frame, a reduced resolution version of the given frame, and a reduced resolution version of a frame acquired prior to the given frame.

16. The video recording device of claim 15, wherein the video stabilizer determines the global motion vector based on sub-pixels of the reduced resolution version of the given frame and the reduced resolution version of a frame acquired prior to the given frame.

17. The video recording device of claim 14, wherein the video stabilizer produces a scaled global motion vector by scaling the global motion vector in accordance with a ratio of pixels in the given full resolution video frame to pixels in a reduced resolution version of the given full resolution video frame.

18. The video recording device of claim 17, wherein the video stabilizer determines a location of a portion of the given full resolution video frame comprising an image window based on the scaled global motion vector.
